(19) United States
(12) Patent Application Publication
(10) Pub. No.: US 2012/0084155 A1
(43) Pub. Date: Apr. 5, 2012

(54) PRESENTATION OF CONTENT BASED ON UTILITY

(75) Inventors: Scott Roy, Palo Alto, CA (US); Belle Tseng, Cupertino, VA (US); Pradheep Elango, Mountain View, CA (US); Bee-Chung Chen, Mountain View, CA (US); Jayavel Shanmugasundaram, Santa Clara, CA (US); Raghu Ramakrishnan, Los Altos, CA (US); Andrei Broder, Menlo Park, CA (US); Deepak Agarwal, Sunnyvale, CA (US); Todd Beaupre, Sunnyvale, CA (US); Nitin Motgi, Santa Clara, CA (US); John Tomlin, Sunnyvale, CA (US)

(73) Assignee: Yahoo! Inc., Sunnyvale, CA (US)

(21) Appl. No.: 12/895,868

(22) Filed: Oct. 1, 2010

(51) Int. Cl. G06Q 30/00; G06N 5/02

(52) U.S. Cl. 705/14.69; 706/52

(57) ABSTRACT

Methods and systems for presenting content such as articles based on utility are provided. In one embodiment, a plurality of articles are determined, each article in the plurality of articles including article content and a corresponding preview icon, the preview icon defining a link to the corresponding article content when presented. For each article in the plurality of articles, a user experience utility value is determined. And for each article in the plurality of articles, an economic utility value is also determined. A ranked order of the articles is determined based upon each article's user experience utility value and economic utility value. And a portion of the preview icons of the articles are presented on a graphical display page in a priority orientation based on the ranked order of the articles.

### BACKGROUND

1. Field of the Invention

The present invention relates to methods and systems for displaying content on a graphical display page based on the expected utility of each choice.

2. Description of the Related Art

A web portal is generally an Internet web page which presents content from several different sources to a user. Web portals may include or contain links to various types of content such as articles, video, pictures, news, finance, sports, and entertainment. Portals may also provide access to numerous services such as an internet search tool, e-mail, maps, etc. Examples of public web portals include the Yahoo! homepage.

It is in this context that embodiments of the invention arise.

### SUMMARY

Broadly speaking, embodiments of the present invention provide methods and systems for presenting content in a priority orientation on a graphical display page, so as to optimize multiple objectives. In various embodiments of the invention, an optimal selection of content is determined based on several factors. These factors include features and characteristics of the content to be displayed on the graphical display page and characteristics of the user. Several inventive embodiments of the present invention are described below.

In one embodiment, a method is provided for presenting recommended pieces of content from a plurality of content. In one specific embodiment, the content includes a number of articles. According to the method, a plurality of articles is determined, each article in the plurality of articles including article content and a corresponding preview icon, the preview icon defining a link to the corresponding article content when presented. For each article in the plurality of articles, a user experience utility value and an economic utility value are determined. A ranked order of the articles is determined based upon each article's user experience utility value and economic utility value. A portion of the preview icons of the articles is presented on a graphical display page in a priority orientation based on the ranked order of the articles.

In one embodiment, the user experience utility value is determined based upon a probability that a user will select the article's preview icon when presented.

In one embodiment, the economic utility value is determined based upon an expected commercial value of advertisements to be presented with the article content of a particular article when the article's preview icon is selected.

In one embodiment, user features of a user are determined, the user features including data which describes characteristics of the user. And the user experience utility value is determined based at least in part on the user features. In one embodiment, the user features are selected from the group consisting of age, gender, and location.

In one embodiment, the portion of the preview icons of the articles are presented on the graphical display page in a priority orientation based on the ranked order of the articles and satisfaction of a set of constraints. In one embodiment, the set of constraints includes a variety constraint, the variety constraint requiring that the portion of the preview icons of the articles include more than one type of article. In another embodiment, the set of constraints includes a placement constraint, the placement constraint requiring that a specific preview icon of an article be included in the portion of preview icons of the articles which are presented.

In one embodiment, the article content of the articles includes content selected from one or more of the following: news, pictures, text, photos, graphics, audio, video, stories, games, shopping, weather, sports, entertainment, business, finance, health, science, calendar, personal planner, email, real estate, music, maps, personals, travel, groups, instant messaging, tracking, monitoring, utilities, and editors.

In another embodiment, a method is provided for presenting articles from a plurality of articles on a graphical display page. According to the method, a plurality of advertisements are obtained from advertisers, the advertisers defining content for the advertisements and assigning a commercial value to each of the advertisements. The commercial value represents a cost to the advertiser when the advertisement is presented to or selected by a user. A plurality of articles is obtained, each of the articles having article content and a preview icon. The preview icon defines a link to its corresponding article content when presented on a graphical display page. A user profile is identified for a selected user that interfaces with a graphical display page that is to present one or more of the preview icons of the obtained articles. A probability value is obtained for the selected user for each one of the plurality of articles, the probability value defining which ones of the preview icons of the plurality of articles is most likely to be viewed by the selected user. A commercial value is obtained for the selected user for each one of the plurality of articles, the commercial value determined based on advertisements which are to be displayed with a given article's article content when presented. The probability value is combined with the commercial value. And a set of preview icons of the articles is presented on the graphical display page in a priority orientation, such that the priority orientation defines an optimal placement based on the commercial value and the probability value.

In one embodiment, the user profile for the selected user includes data which describes characteristics of the selected user. In one embodiment, the characteristics of the selected user are selected from the group including age, gender, location, topics of interest, and sources of interest. In one embodiment, the characteristics of the user include content preferences of the selected user when interacting with the graphical display page. In one embodiment, the content preferences of the selected user are determined by tracking the interactions of the selected user with the graphical display page.

In one embodiment, the probability value for each one of the plurality of articles is determined based on the user profile and characteristics of the one of the plurality of articles.

In another embodiment, a computer program product comprising program instructions embodied on a computer readable medium is provided. The computer program product includes program instructions for determining a plurality of articles, each article in the plurality of articles including article content and a corresponding preview icon, the preview icon defining a link to the corresponding article content when presented. Program instructions are provided for determining a user experience utility value for each article in the plurality of articles. The computer program product includes program instructions for determining an economic utility value for each article in the plurality of articles. Program instructions are provided for determining a ranked order of the articles based upon each article's user experience utility value and economic utility value. Program instructions are included for presenting a portion of the preview icons of the articles on a graphical display page in a priority orientation based on the ranked order of the articles.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 illustrates a diagram showing selection and presentation of content on graphical display pages to different users, in accordance with an embodiment of the invention.

FIG. 2 illustrates exemplary graphical display pages, illustrating presentation of preview icons, expanded preview windows, and article content, in accordance with an embodiment of the invention.

FIG. 3 illustrates a system for presenting selected articles on a graphical display page to a user, in accordance with an embodiment of the invention.

FIG. 4 illustrates an article storage module, in accordance with an embodiment of the invention.

FIG. 5 illustrates an advertisement storage module, in accordance with an embodiment of the invention.

FIG. 6 illustrates components for rendering a graphical display page, in accordance with an embodiment of the invention.

FIG. 7 illustrates a flow diagram showing a method for modeling user interactivity with a graphical display page so as to determine the probability that a user will take a particular action, in accordance with an embodiment of the invention.

FIG. 8 illustrates a flow diagram showing a method for scoring content to be displayed on a graphical display page, in accordance with an embodiment of the invention.

FIG. 9 illustrates a method for determining articles to present on a graphical display page, in accordance with an embodiment of the invention.

FIG. 10 illustrates a graph showing revenue vs. clicks, in accordance with an embodiment of the invention.

FIG. 11 illustrates a graph illustrating experimental results of RPV vs. CTR, in accordance with an embodiment of the invention.

FIGS. 12A and 12B illustrates graphs showing distribution of traffic over three properties, in accordance with an embodiment of the invention.

FIG. 13 illustrates a graph showing traffic distribution across various properties before and after optimization of content has been performed so as to achieve certain objectives, in accordance with an embodiment of the invention.

### DETAILED DESCRIPTION

The following embodiments describe systems and methods for displaying recommended articles on a graphical display page. Articles may be ranked according to a utility function, which is based on an economic utility and a user experience utility of the article.

It will be obvious, however, to one skilled in the art, that the present invention may be practiced without some or all of these specific details. In other instances, well known process operations have not been described in detail in order not to unnecessarily obscure the present invention.

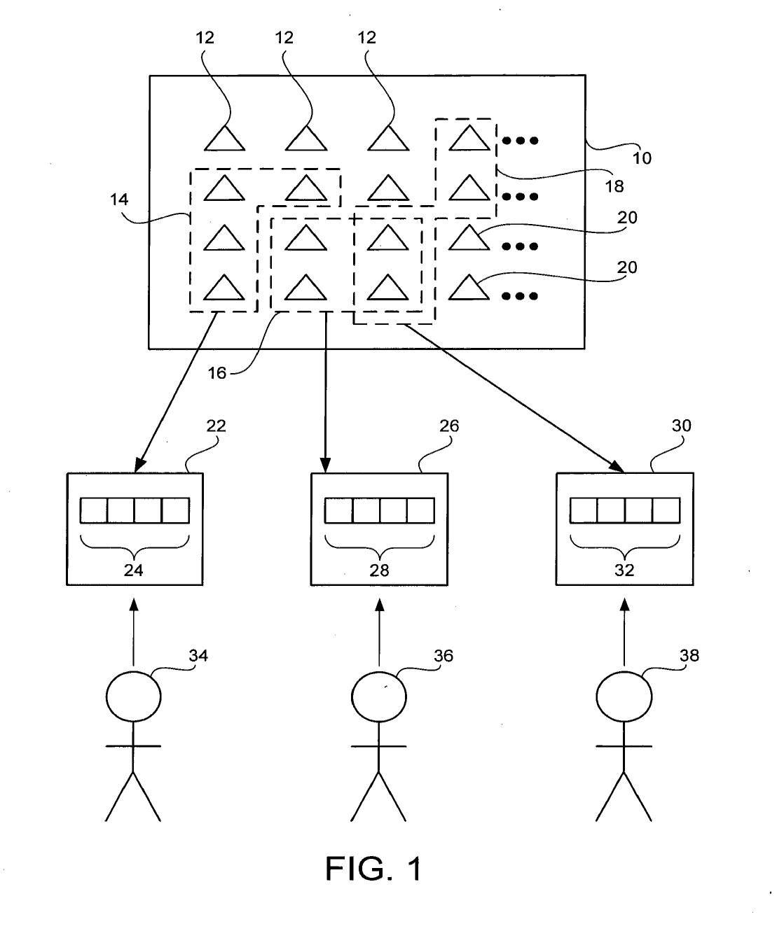

With reference to FIG. 1, a diagram illustrating selection and presentation of content on graphical display pages to different users is shown, in accordance with an embodiment of the invention. A content pool 10 includes various content pieces 12. Each of the content pieces 12 may include any type of content that may be ranked and presented in a priority orientation on a graphical display page based on expected utility, as will be described in various embodiments herein.

Examples of content which may be included in the content pieces include text, images, video, audio, combinations thereof, and any other types of content which may be presented on a graphical display page. In some embodiments, the content pieces 12 are articles, wherein each article may be defined to include various related items or portions, such as article content, a preview icon, and an expanded preview window. Typically, the article content is the main portion of an article, including content that is intended to be communicated by the article in full-fledged form. The article content may include any of various kinds of content which may be presented on a graphical display page, such as text, images, pictures, photos, video, etc.

The preview icon of an article is an icon or thumbnail image which briefly communicates the contents of the article content. The preview icon may include an image or a headline or other brief description of the article content. It will be understood by those skilled in the art that the preview icon may or may not include an image, and in some embodiments the preview icon includes only text, such as a headline. The preview icon simply consists of some content which can be presented to briefly communicate or otherwise suggest the contents of the article content. The preview icon may be configured to contain a link to the article content (or to a graphical display page which presents the article content) when presented on a graphical display page. The expanded preview window provides a preview of the article content, but in greater scope or detail than that provided by the preview icon. The expanded preview window can include images and additional descriptive text which describes the contents of the article content. The expanded preview window may also be configured to include a link to the article content when presented on a graphical display page. In one embodiment, the preview icon and expanded preview window are presented together on the same graphical display page. For example, the preview icon and expanded preview window may be configured so that hovering a pointer over or otherwise indicating interest in the preview icon may cause the corresponding expanded preview window to be shown on the graphical display page. In this manner, a user can progress from viewing a limited amount of descriptive information in a preview icon, to a greater amount of descriptive information in the expanded preview window, to finally navigating to the full-fledged article content itself.

A user 34 views a graphical display page 22, which in one embodiment may be a web portal page or other type of web page. The page 22 includes a featured content section 24, which is configured to display selected content based on expected utility. The mechanism for determining which content will be featured in the featured content section 24 of a particular user is described in further detail below. As shown, the user 34 receives content pieces 14 on the featured content section 24 of graphical display page 22. Whereas user 36 receives content pieces 16 on the featured content section 28 of graphical display page 26. And user 38 receives content pieces 18 on the featured content section 32 of graphical display page 30.

As can be seen, the different users 34, 36, and 38 may not have the same content pieces featured on their respective graphical display pages, as the particular content featured on a graphical display page for a particular user may vary based on various factors such as characteristics of the user. In the illustrated example, the content pieces 14 featured on graphical display page 22 are wholly different from the content pieces featured on graphical display pages 26 and 30. Whereas the content pieces 16 featured on graphical display page 26 include two content pieces 20 in common with the content pieces 18 which are featured on graphical display page 30. Thus, different graphical display pages which are presented to different users may include the same or different featured content.

In one embodiment, wherein the content pieces are articles as described above, the featured content section 24 is configured to display preview icons of selected articles. The mechanism for determining which articles will be featured in the featured content section 24 of a particular user is described in further detail below. As shown, the user 34 receives preview icons of articles 14 on the featured content section 24 of graphical display page 22. Whereas user 36 receives preview icons of articles 16 on the featured content section 28 of graphical display page 26. And user 38 receives preview icons of articles 18 on the featured content section 32 of graphical display page 30.

As can be seen, the different users 34, 36, and 38 may not have the same articles featured on their respective graphical display pages, as the particular articles featured on a graphical display page for a particular user may vary based on various factors such as characteristics of the user. In the illustrated example, the articles 14 featured on graphical display page 22 are wholly different from the articles featured on graphical display pages 26 and 30. Whereas the articles 16 featured on graphical display page 26 include two articles 20 in common with the articles 18 which are featured on graphical display page 30. Thus, different graphical display pages which are presented to different users may include the same or different featured articles.

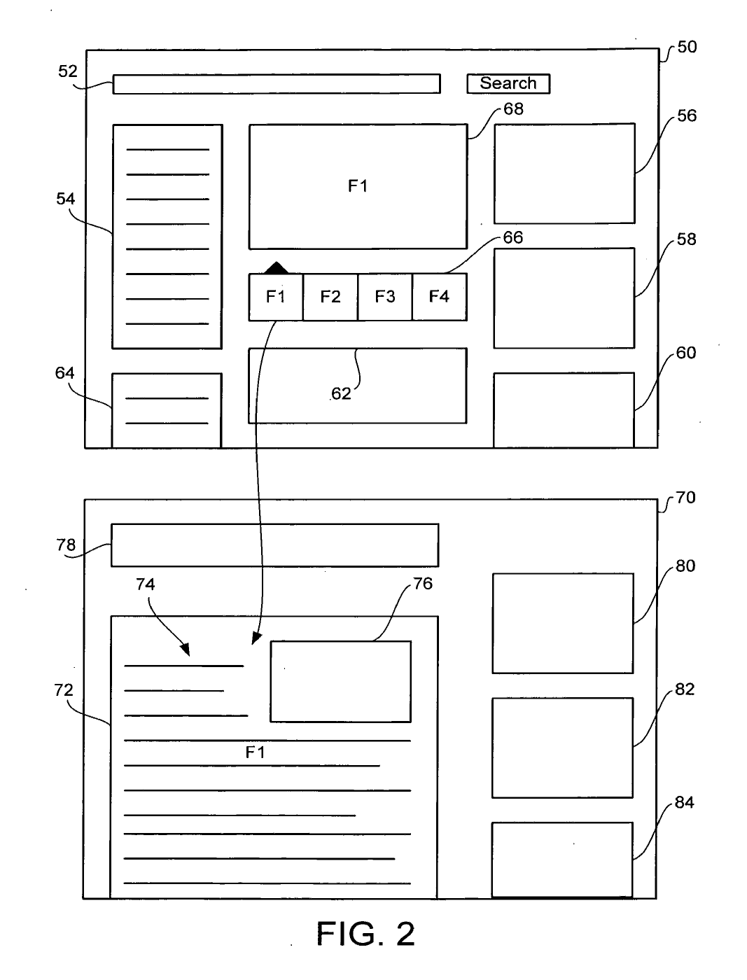

With reference to FIG. 2, exemplary graphical display pages are shown, illustrating presentation of preview icons, expanded preview windows, and article content, in accordance with an embodiment of the invention. As shown, a graphical display page 50 includes several different types of content. In one embodiment, the graphical display page 50 is a web portal page. By way of example, the page 50 includes a search bar 52 wherein a user may enter search criteria and execute an internet search. A sidebar 54 may provide links to various sites providing different kinds of functionality or content, such as e-mail, finance, classifieds, shopping, sports, weather, and other types of sites. A sidebar 64 provides links to favorite sites, as designated by the user. If no favorite sites have been designated by the user, or the user is not logged in, then various sites may be selected automatically and shown in the sidebar 64, based on known information such as time of day or geographic location of an originating IP address.

Side panels 56, 58, and 60 may display various kinds of content. For example, in one embodiment, a side panel displays currently popular search topics. The side panels may also present multimedia contents, such as photos, images, videos, music, interactive applications, etc. The side panels 56, 58, or 60 may also be utilized to present advertisements to the user. A content window 62 may be configured to present headlines of interest or other types of content. The foregoing examples of panels and content sections provided on a graphical display page are provided by way of example only, and not by way of limitation. In other embodiments, the graphical display page 50 may include any type of content and may have any arrangement of such content as may be presented on a graphical display page.

The graphical display page 50 further includes a featured articles section which includes a preview panel 66 and an expanded preview panel 68. The preview panel 66 is utilized to display preview icons of selected articles, as described above. And the expanded preview panel is utilized to display expanded preview windows of the selected articles, as also described above. In the illustrated embodiment, the preview panel includes four positions for showing preview icons. As shown, preview icons for articles F1, F2, F3, and F4 are currently being displayed on the graphical display page 50. The expanded preview panel 68 displays one expanded preview window of an article at a time. In the illustrated embodiment, the expanded preview panel 68 is currently displaying the expanded preview window of the article F1.

On loading, the graphical display page 50 may be configured to display the expanded preview window of the article whose icon is shown in the first position of the preview panel 66, as is the case in the illustrated embodiment, wherein the preview icon of article F1 occupies the first position of the preview panel 66. However, when a user hovers a pointer over a preview icon of a different article, such as the preview icons of F2, F3, or F4, then the expanded preview panel 68 may be configured to display the expanded preview window of the article whose preview icon is presently being hovered over. Thus, the contents of the expanded preview panel 68 may change depending upon input from the user.

A given preview icon and expanded preview window, when presented on the graphical display page 50, are configured to provide a link to a graphical display page which presents the corresponding article content. Thus, as shown in the illustrated embodiment, when the user selects (such as by clicking a pointer or tapping a touchscreen display) the preview icon for article F1, then the user is navigated to a graphical display page 70, which contains corresponding article content 72. The article content 72 may include various types of content such as text 74 and multimedia content 76, such as images or video. The graphical display page 70 may also include other content panels 78, 80, 82, and 84, which may contain various types of content, such as advertisements, applications, other article content, related headlines, etc.

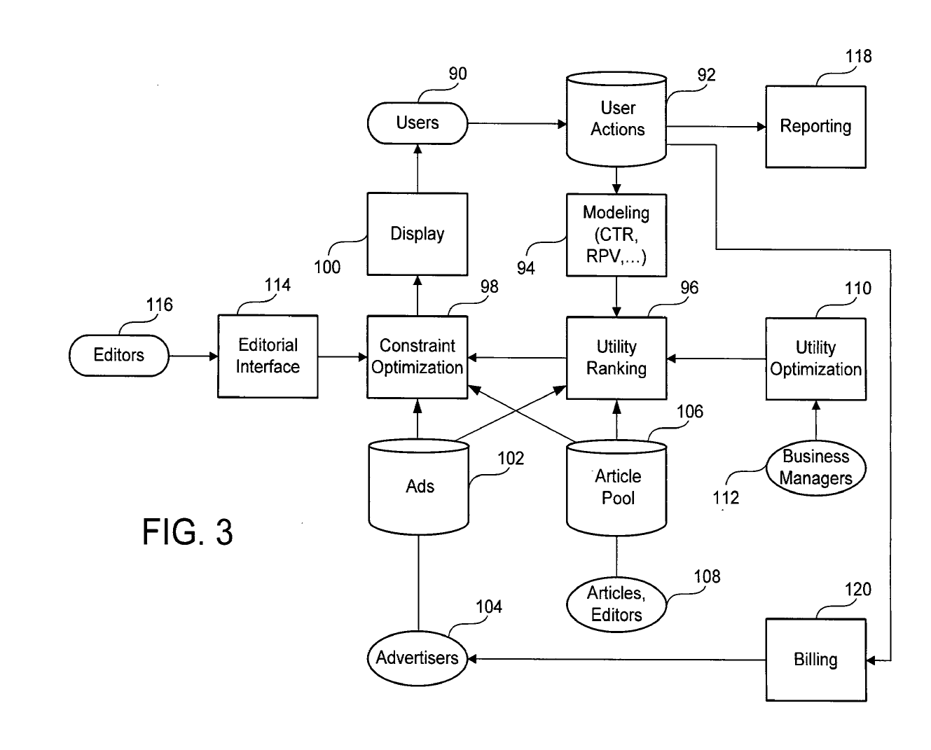

With reference to FIG. 3, a system for presenting selected articles on a graphical display page to a user 90 is shown, in accordance with an embodiment of the invention. The user 90 interacts with a graphical display page which is rendered by display system 100. The display system 100 includes components which are utilized for generating and rendering the graphical display page to the user, and may include different components depending on the context in which the graphical display page is to be rendered.

For example, in one embodiment, the display system 100 may include a server computer for generating the graphical display page, a network for communicating the graphical display page, a personal computing device for receiving the graphical display page, and a display which is connected to or otherwise integrated with the personal computing device for reproducing the graphical display page in visual format. Examples of displays include monitors, televisions, projectors, etc. In various embodiments, the computing device may be any device capable of receiving the graphical display page, such as a computer terminal, a desktop computer, a laptop computer, a personal digital assistant (PDA), smartphone, cellular phone, netbook, etc. The network may be wired (e.g. digital subscriber line, cable, fiber optic, etc.), wireless (e.g. satellite, cellular, etc.), or incorporate both wired and wireless technologies for data transmission. The network may be a local area network (LAN), wide area network (WAN), the Internet, or any other type of network useful for transmitting data.

In one embodiment, the graphical display page is a web page. Thus, the display system 100 may include a web server for generating the web page. The web server may be connected to the Internet for transmission of the web page. The user 90 uses a personal computing device to receive and display the web page.

In other embodiments, the graphical display page may be any type of display page upon which articles may be displayed or recommended to a user. For example, the graphical display page may be rendered by an application running on the user's personal computing device. The application may connect to a remote server via a network. The remote server may provide data to enable the application to render the graphical display page.

The graphical display page may be utilized to display various kinds of content, such as text, pictures, video, etc. In some embodiments, the graphical display page may be a web portal. The web portal may include various types of content or provide links to different kinds of content, such as news, sports, finance, entertainment, personals, shopping, travel, job search, maps, movies, autos, etc. While a web portal is one example of a web page which is a type of graphical display page, other types of web pages and graphical display pages may be utilized which may contain various kinds of content.

Throughout this disclosure, reference will generally be made to embodiments directed to the display of a web page as an embodiment of a graphical display page. However, it should be understood that the principles described herein may be applied to other contexts and other types of graphical display pages without departing from the scope of the present invention. For example, the graphical display page may be generated by a standalone or locally hosted program or application.

In one embodiment, the graphical display page is a web portal. As discussed above, a web portal may provide a variety of different kinds of information and content in a unified location. However, the user may wish to additionally customize the web portal to their liking, so as to provide a richer experience tailored to their preferences. The web portal may be configured to facilitate this by enabling a user to save personal settings which are specific to the user and which affect or determine various aspects of the web portal that is presented to the user. For example, a user who is interested in a particular subject area might indicate as such as a part of their personal settings for the web portal. Then when the user views the web portal, the web portal may be customized to provide or highlight content which relates to the subject area in an integrated manner as part of the web portal which is presented to the user.

With continued reference to FIG. 3, the user 90 may interact with a graphical display page in various ways. For example, the user 10 may perform actions such as clicking on a link, navigating to a particular page, hovering over particular content, playing multimedia content, entering text (e.g. entering search query terms), adding an application to a group of personalization applications, etc. Additionally, data relating to interactions may be of significance, such as the amount of time spent on a particular page of a web portal. It should be appreciated that examples of interactions with a graphical display page discussed herein are provided merely by way of example, and not by way of limitation. In alternative embodiments of the invention, any type of interaction with a graphical display page may be recorded. To facilitate interactions with a graphical display page, any of various types of interfaces may be utilized without departing from the scope of the invention. Examples of interfaces which facilitate interaction with a graphical display page include, but are not limited to, a keyboard, mouse, trackball, touchpad, joystick, speech or audio recognition interface, stylus, touch-sensitive display, motion detection interfaces and other types of interfaces.

The user interactions with the graphical display page are captured and recorded in a user actions database 92. In exemplary embodiments of the invention, the user interactions are captured by server logs which record the activity of a user interacting with a graphical display page. As explained in further detail below, the raw captured data may be converted to logical events which are indicative of the significance of each of the user's captured interactions. These logical events are then communicated to a modeling module 94.

The modeling module 94 receives the logical events and generates or updates models which can be utilized to determine the probability that a given user will take a particular action when presented with certain content on the graphical display page. The modeling module 94 may include various models for predicting various items of interest. For example, in one embodiment, the modeling module 94 includes models for determining the probability that a specific user will click on a preview icon of a particular article presented on a graphical display page (i.e. the click through rate (CTR) of the preview icon).

In various embodiments, the modeling module 94 may include various models for predicting various items of interest. In one embodiment, the modeling module 94 includes models for predicting downstream user engagement with a given property. A downstream event refers to an event occurring after the user navigates to a new graphical display page from an initial graphical display page, such as may occur when a user clicks on the preview icon or expanded preview window of a given article, and therefore navigates to a new graphical display page which displays the article content of the article. One example of a measure of downstream user engagement includes the amount of time spent by a user after navigating to a new page, either before navigating to another page, or inclusive of time spent on other downstream pages which are reached from the new page. Another example of a measure of downstream user engagement includes a number of page views by the user after navigating to a new page. In other embodiments, models may be included in the modeling module 94 for predicting other metrics of interest such as comScore metrics. The foregoing examples of items of interest which may be modeled and predicted are provided by way of example only, and not by way of limitation. In other embodiments, any item of interest relating to user behavior or interaction with a graphical display page may be modeled, provided that relevant data regarding such behavior or interactions can be gathered.

To determine or predict an item of interest such as the probability that a user will take a particular action, the modeling module 94 applies any of various models to input data. The input data includes the aforementioned logical events, but also may include various data relating to the user's experience of the graphical display page. For example, such input data may include content features which include data that describes characteristics of the content, such as topic, keywords, source, author, and other descriptive information relating to the content presented. Such input data may also include user features which include data that describes characteristics of the user. Examples of characteristics of the user may include, but are not limited to, age, gender, address, location, ethnicity, vocation, income, etc. The user features may further include the personal settings of the user and the interaction history of the user when accessing the graphical display page, as well as other user information which may correlate with or affect the likelihood that the user will take the particular action for which the modeling module 94 calculates a probability. The input data for the modeling module 94 may also include context features, which includes data which describes the context in which the user will view the graphical display page. For example, the context features may include the time of day, data regarding the type of device on which the user views the graphical display page (e.g. desktop personal computer, laptop, mobile device such as cell phone or pda, etc.), the size of the display on which the graphical display page is viewed, the type of network being used, the type of interface devices being used, etc. The aforementioned logical events, user features, and context features are merely examples of types of input data which may be received by the modeling module 16 for purposes of determining the probability that the user will take a particular action. In other embodiments, the input data for the modeling module may include any type of data which is useful for determining the probability that the user will take a particular action.

The models of the modeling module 94 are continually refined based on the received input data taken in conjunction with result data (e.g. whether or not the user clicked on a preview icon). As described in further detail below, this data is utilized as training data to update the models. Thus, the input data is not only used for purposes of determining the probability of the user taking a particular action, but is also utilized to help ensure that the models which are applied to determine that probability are improved over time as more data becomes available.

With continued reference to FIG. 3, an advertisement storage module 102 stores advertisements which are developed and submitted by advertisers 104. The advertisements may include creative components such as icons, graphics, information, audio, video, animations or other related content which may be utilized to present an advertisement to a user on a graphical display page. The advertisements may also include links to web pages, and other functional mechanisms such as data generating mechanisms which enable tracking of the advertisement's display and various interactions with the advertisement.

Also, the advertisement storage module 102 may also store data relating to the commercial value of the advertisements. For example, in one embodiment the commercial value of advertisements are based on bids which are received from the advertisers 104 and associated with their respective advertisements. The bids represent a cost to be paid by the advertisers when a user performs a certain action. For example, a advertiser may submit a bid that is a cost-per-click (CPC) that the advertiser is willing to pay to the owner of the graphical display page when the advertiser's advertisement creative is clicked on by a user. Other examples of possible bids include cost-per-impression bids (e.g. cost that advertiser pays when their advertisement creative is displayed or hovered over), and cost-per-action or cost-per-acquisition (CPA) bids (e.g. cost that advertiser pays when some action is performed which flows from the advertisement's presentation, such as the user making a purchase or a form submission). In other embodiments, the bids or commercial values may be distinct from, but nonetheless related to, the actual cost that would be paid by an advertiser. For example, a bid may represent a maximum value that an advertiser is willing to pay for a specific action, whereas the actual cost paid by the advertiser might be a value that is a minimum increment greater than the next highest bid. It will be understood by those skilled in the art that bids or commercial values may be received according to various auction formats, such as first price auctions, second price auctions, Vickrey auctions, etc. The foregoing examples of bids and commercial values are provided by way of example only, and not by way of limitation, as any type of bid or commercial value may be assigned to an advertisement by an advertiser, these being stored in the advertisement storage module 102.

Additionally, some advertisements may be characterized as non-guaranteed advertisements, wherein no guarantee is provided by the owner of the graphical display page that a specific advertisement will be shown a predetermined number of times. Whereas other advertisements may be characterized as guaranteed advertisements, wherein the owner of the graphical display page guarantees that the advertisement will be shown a minimum number of times, or else pay a penalty for under-delivery of the advertisement. The advertisement storage module 102 may thus include data relating to the non-guaranteed or guaranteed nature of the advertisements.

With continued reference to FIG. 3, an article pool storage module 106 stores a pool of articles which have been selected by articles editors 108. The pool of articles is a predetermined group of articles which may be featured on a graphical display page, as has been described. In one embodiment, there is a predetermined limit on the number of articles permitted in the article pool, such that when the article pool is full, an existing article is removed for every one new article which is inserted into the article pool. In other embodiments, the number of articles in the article pool may change. Additionally, there may be rules applied to the articles permitted in the article pool. For example, a staleness rule could be implemented in which articles cannot be in the article pool for greater than a certain amount of time, or the date of publication of the articles in the article pool cannot be older than a certain date.

With continued reference to FIG. 3, a utility ranking module 96 is provided. The utility ranking module 96 utilizes information from the modeling module 94 and determines a ranked order of the articles in the article pool, according to which their preview icons may be displayed on a graphical display page. In one embodiment, the ranked order is determined based on a combination of factors including a probability that a user will select the preview icon of a particular article, and an expected value of a second graphical display page upon which the corresponding article content is presented, the second graphical display page being presented when the preview icon is selected. The expected value of the second page may be based on a bid or commercial value associated with advertisements which will be displayed on the second page, as received from the advertisement storage module 102.

It is noted that in other embodiments, wherein a content pool is generically provided, then a ranked order for the content in the content pool may be determined based on a combination of factors such as those presently described. These may include the probability that a user will select the content and an expected revenue associated with the content when it is selected. The expected revenue associated with a content piece may, for example, be based on advertising presented with the content.

In one embodiment, a ranking method employed by the utility ranking module 96 to determine the ranked order of the articles in the article pool employs a utility function. In one embodiment, the utility function is based at least in part on the aforementioned factors—i.e. the probability that the user will select the preview icon of an article and the expected value of a downstream graphical display page which displays the corresponding article content when the preview icon is selected. The ranked order of the articles is determined by scoring each of the articles in the article pool for a given user according to the utility function. Those articles having the highest value will generally be the articles which are featured on a graphical display page to the user (possibly subject to certain constraints). In essence, the utility function is maximized across the pool of articles for a specific user by determining those articles which maximize the value of the utility function.

In various embodiments of the invention, the particular factors included in the utility function may vary to a large extent. The utility function may incorporate various considerations such as user experience related utilities, which pertain to the quality of the user experience, and economic utilities, which pertain to the potential revenue which may flow from a given graphical display page. It will be appreciated by those skilled in the art that in other embodiments of the invention, the particular ranking method utilized by the utility ranking module 96, as well as the various factors which are included in such a ranking method, may vary considerably. The examples provided herein of various factors and particular scoring methods should be understood as merely exemplary embodiments, and are not intended to limit the scope of the invention in any way.

For example, with continued reference to FIG. 3, utility optimization interface 110 provides an interfacing mechanism for enabling business managers 112 to affect the scoring method employed by the utility ranking module 96 so as to optimize the scoring method for a desired factor or balance of factors. For example, the optimization criteria may include revenue. By adjusting the optimization criteria of revenue via the utility optimization interface 110, the business managers 112 can affect the relative importance of revenue in the scoring method applied by the utility ranking module 96, which ultimately affects the score results for the articles in the article pool. Thus, if the business managers 112 choose to set the optimization criteria of revenue at a very high level, then the scoring method will be optimized so as to place a high importance on revenue. The results of the scoring method will therefore be optimized so that the highest scoring articles according to the utility function will tend to be those which yield the highest revenue. Conversely, if the business managers 112 set the optimization criteria of revenue to be very low, then the scoring method will place little emphasis on revenue, and the results of the scoring method will tend to not be optimized for revenue. (However, it is theoretically possible for the highest scoring results to nonetheless include articles which provide high revenue if the scoring method applied to the articles coincidentally yields such score results. But this would be a secondary result of optimizing for criteria other than revenue.)

In one embodiment, the optimization criteria which may be adjusted via the utility optimization interface 110 includes click through rate (CTR). When the optimization criteria of CTR is increased, then the scoring method applied by the utility ranking module 96 is adjusted so that the relative importance of CTR in determining the overall score of articles is increased. Thus, by increasing the degree to which the utility scoring method optimizes for CTR, the business managers 112 can ensure that the highest scoring results will tend to be those articles which will provide the highest CTR when presented on the graphical display page. In other words, the highest scoring articles will tend to be those that users are most likely to click through.

In one embodiment, the optimization criteria may include a downstream user engagement criteria. As noted, downstream user engagement may be based on predicted measures of user engagement with a property such as the expected time spent on a downstream page, or the expected number of page views during a session. When the downstream user engagement criteria is increased, then the utility function applied by the utility ranking module 96 is adjusted so as to place a greater emphasis on downstream user engagement. Therefore, articles which tend to promote greater downstream user engagement are more likely to score highly according to the utility function.

In another embodiment, the optimization criteria may include an editorial voice criteria. The editorial voice is the desired voice and image which the owner of the graphical display page wishes to convey to the user. Thus, when the optimization criteria of editorial voice is increased, the scoring method is adjusted so that editorial voice is given a higher relative importance. The scored results are therefore more likely to yield articles which are consistent with the desired editorial voice or image as the higher ranking articles according to the utility function.

In one embodiment, the optimization criteria may include a partnerships criteria. The partnerships criteria is indicative of strategic partnerships which the owner of the graphical display page may wish to promote through the selection of certain articles. Therefore, increasing the partnerships criteria increases the extent to which strategic partnerships are factored into the scoring of the various articles under consideration. Conversely, decreasing the partnerships criteria decreases the extent to which strategic partnerships are considered when scoring the articles.

The foregoing examples of optimization criteria are provided by way of example only, and not by way of limitation. In other embodiments of the invention, the optimization criteria may include any criteria or factor which may be included in the utility function, such as various comScore metrics or other downstream metrics of interest. Additionally, various optimization criteria may be linked, such that adjustment of one criteria will cause adjustment of another criteria simultaneously, either in a similar manner or in an opposite manner. For example, in one embodiment wherein adjustment of CTR and revenue are linked in an opposing manner, the utility function may be configured such that adjustment of CTR in a positive direction causes adjustment of revenue in a negative direction.

The business managers 112 may be any persons with authority to determine optimization criteria for the scoring methods utilized by the utility ranking module 96. While various examples of optimization criteria have been described herein, these are provided by way of example only and not by way of limitation, as the optimization criteria may include any criteria according to which the scoring method of utility ranking module 96 may be tailored to suit desired outcomes.

With continued reference to FIG. 3, a constraint optimization module 98 is provided to enable application of editorial constraints that affect which articles are selected, from the ranked order of articles as determined according to the utility function, for display on a graphical display page. An editorial interface 114 is provided for enabling editors 116 to determine and apply editorial constraints to the selection of articles.

In one embodiment, the editorial constraints may include a variety constraint to enhance the user's experience by ensuring a variety of articles are presented on the graphical display page. Such a variety constraint may thus prevent the display of too many of the same kind of article, or prevent the recurring display of the same article, or otherwise ensure that a variety of articles are presented to the user. In one embodiment, an editorial constraint may ensure that a particular article appears within the top ranking results of the scoring method, thereby guaranteeing that the particular article will be displayed on the graphical display page. Or in another example, the editorial constraints may provide for the insertion of a particular article into a specific spot within the top ranking results of the scoring method, regardless of the article's actual score based on the utility function. Such features may act as overrides to the scoring method, allowing the editors 116 to ensure that a particular article will be selected for display on the graphical display page regardless of its actual scored result according to the utility function. Yet another example of an editorial constraint may provide that a particular article cannot appear above a certain ranking within the ranked results, thereby ensuring that the particular article will not be presented above a certain rank on the graphical display page. Or a constraint may provide for the opposite situation, wherein a particular article must appear above a certain ranking within the ranked results. Still other kinds of editorial constraints may provide for session-related constraints, such as a constraint which ensures that a particular article is presented at least once during a session. The foregoing examples of editorial constraints are provided by way of example only and not by way of limitation. In other embodiments, the editorial constraints may include any type of rule or constraint that is applied to the optimized results of the scoring method, so as to affect the selection of the articles for display on the graphical display page in a manner independent of the above-mentioned optimization criteria.

In summary, the utility ranking module 96 applies a scoring method including a utility function to the articles in the article pool so as to determine a ranked order of the articles as candidates for display on the graphical display page. The scoring method may be affected by various optimization criteria via the utility optimization interface 110, and the final ranked order of the articles may be further subject to various constraints which may be adjusted via editorial interface 114. The preview icons of the articles having the highest final ranking are selected for presentation on a graphical display page via the display system 100.

While reference has been made to the articles in the article pool storage module 106, in other embodiments of the invention, module 106 can be a content pool storage module 106 configured to store any of various kinds of content which may be presented on a graphical display page. The content in the content pool can be evaluated, scored, ranked, and optimized for display on a graphical display page in accordance with the methods herein described.

With continued reference to FIG. 3, a reporting module 118 is provided for generating reports based on data from the user actions database 92. The reporting module 118 may include an interface to enable a user of the reporting module 118 to generate custom reports tailored to their specific needs. The reporting module 118 may also be configured to automatically generate systematic reports based on data retrieved by polling the user actions database 92 at regular intervals or times.

With continued reference to FIG. 3, a billing module 120 is provided for generating and delivering billing information to the advertisers 104 of advertisements which are presented to the users 90. The billing module 120 receives data from the user actions database 92 which indicates the interactions with the advertisers' advertisements. The billing module 120 also receives the commercial values of the interactions from the advertisement storage module 102 (e.g. CPC, CPM, CPA, etc.). Based on these interactions and their corresponding commercial values, the cost to be paid by the advertisers 104 is determined by the billing module 120, and reported to the advertisers 104 for payment.

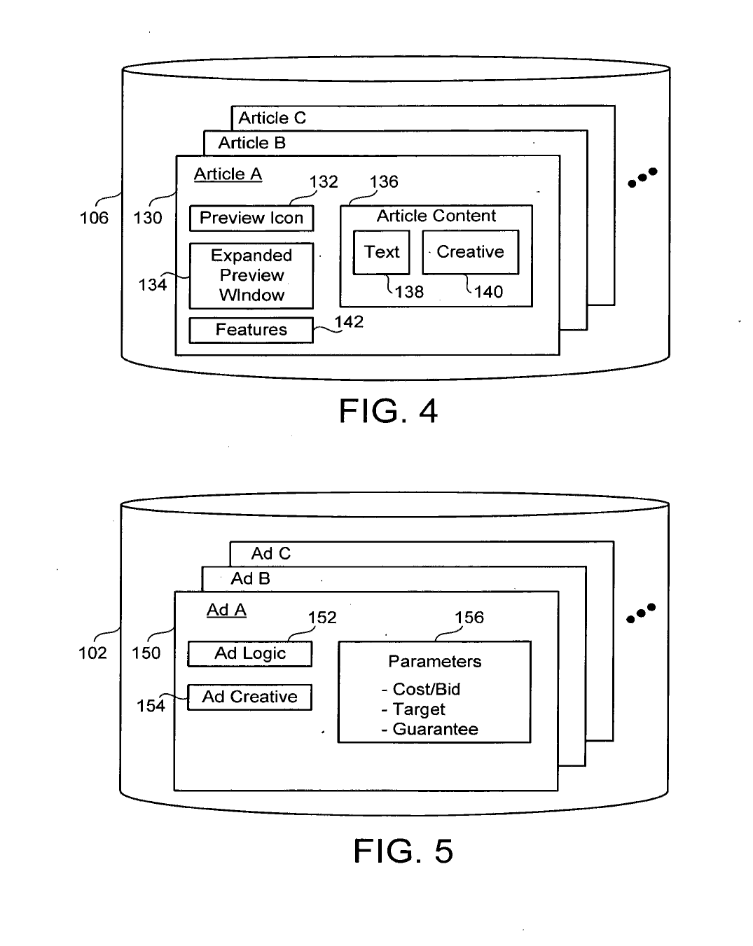

With reference to FIG. 4, an article storage module 106 is shown, in accordance with an embodiment of the invention. The article storage module 106 includes various articles which may be presented to a user on a graphical display page. In one example, an article 130 includes a preview icon 132, which provides a limited preview of the article. An expanded preview window 134 provides a more expanded preview of the article. And the article content 136 constitutes the full-fledged content of the article. The article content 136 may include various types of content, such as text 138 and creatives 140. The creatives 140 may include any of various kinds of media, such as images, audio, or video content. Additionally, the article 130 includes features 142, which include various descriptive parameters relating to the article. For example, the features may include data indicating a type or categorization of the article 130, keywords associated with the article, etc.

With reference to FIG. 5, an advertisement storage module 102 is shown, in accordance with an embodiment of the invention. The advertisement storage module 102 includes various advertisements which may be presented on graphical display pages. In one example, an advertisement 150 includes ad logic 152 which provides code or logic which controls the function of the advertisement. For example, ad logic 152 may include a URL to which the advertisement redirects when it is clicked on. The ad logic 152 might also control the behavior of the advertisement when a user interacts with it. For example, the ad logic might be configured such that when a user hovers a pointer over the advertisement, it causes an expanded display or initiates an animation or video. The ad logic might enable control over features of the advertisement by a user, such as on/off or volume control of audio, expanding or maximizing the advertisement, etc. The advertisement 150 also includes ad creatives 154, which include graphics, audio, video, or other creative components of the advertisement 150. The ad creatives 154 may be rendered according to the ad logic 152.

The advertisement 150 also includes various parameters 156. The parameters 156 may include bids or costs to be paid by an advertiser of the advertisement when the advertisement is presented or interacted with, such as CPM, CPC, or CPA values. The parameters 156 may also include a maximum amount the advertiser will pay for such interactions. The parameters 156 may also include information regarding whether or not the advertisement is a guaranteed advertisement, in which the owner of the graphical display page guarantees the ad will be displayed a certain number of times in a given time period. Additionally, the parameters 156 may include information indicating a specific target audience or a specific property (e.g. a specific graphical display page or a specific section of a web portal) for the advertisement. Additionally, the parameters may include descriptive information about the advertisement, such as keywords, maturity level, dimensions, duration, etc. The foregoing examples of ad logic 152, ad creatives 154, and parameters 156 are provided by way of example only, and not by way of limitation. In other embodiments of the invention, the advertisements included in the advertisement storage module 102 may include any of various types of logic, creatives, and parameters as are relevant to the operation of advertisements as described herein.

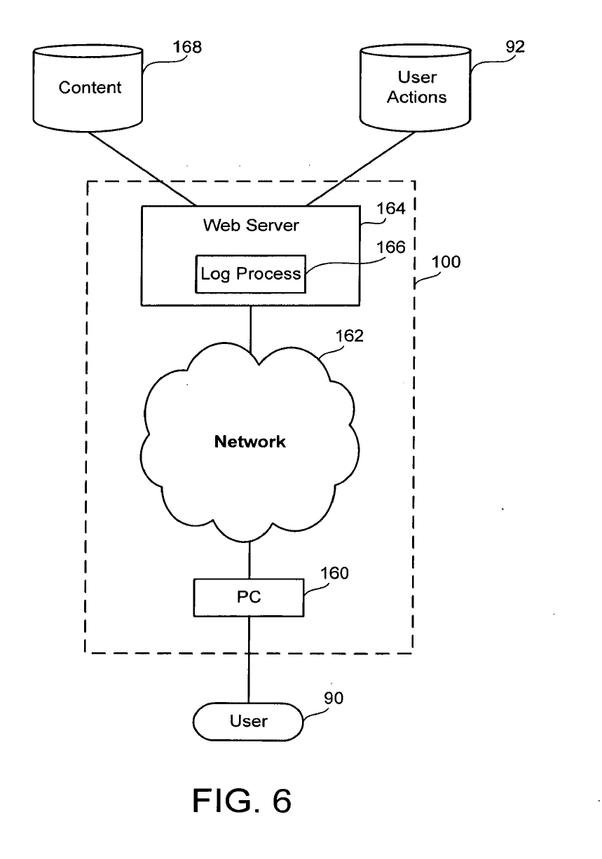

With reference to FIG. 6, components for rendering a graphical display page are shown, in accordance with an embodiment of the invention. The user 90 interacts with a computing device 160 which includes hardware for receiving and displaying a graphical display page to the user 90. As discussed above, the computing device 160 may be a personal computer, laptop, mobile device, or any other type of device configured to receive data for and render a graphical display page to the user 90. The computing device 160 is connected to a server 164 via a network 162. The network 162 may be any kind of network, such as a LAN, WAN, or the Internet, which is capable of transmitting data for a graphical display page from the server 164 to the computing device 160. In one embodiment, the graphical display page is a web page, and the server 164 is a web server. In other embodiments, the server 164 may be any kind of server device or multiple server devices configured to transmit data for a graphical display page to the computing device 160. The server 164 may retrieve data from a content storage 168, which may include the aforementioned articles or advertisements as well as other data utilized to compose the graphical display page. The data transmitted may be utilized to define various portions of the graphical display page. In one embodiment, the transmitted data entirely defines the graphical display page, with the computing device 160 merely interpreting the data for purposes of rendering the graphical display page. In other embodiments, the data transmitted defines some fraction of the graphical display page, with the remainder of the graphical display page being defined by other sources of data. For example, the computing device 160 may retrieve data from sources other than server 164, or may execute processes internally for generating portions of the graphical display page. In various embodiments, the proportion of the graphical display page which is defined by the data transmitted from the server 164 may be any fraction.

Additionally, the server 164 includes a log process 166 for logging raw user actions data resulting from user interactions with the graphical display page. The log process 166 may be configured to log all of the data resulting from the user interactions, or may be configured to selectively log only certain kinds of data which are determined to be of significance for purposes of modeling, scoring, or content selection, as described above. The data which is logged by the log process 166 may be generated based on requests received by the server, responses to the requests, page tags, or any other mechanism for generating data which results from user interactions with the graphical display page. In one embodiment, the log process 96 communicates the raw user actions data to a user actions storage 92 as shown for storage purposes. In another embodiment, the log process may generate a server log at the server 164 which initially stores the raw user actions data. The user actions storage then retrieves the raw user actions data from the server log for storage in the user actions storage 92.

The raw user actions data may include any type of data which is generated as a result of user interactions with a graphical display page. Examples of types of data recorded as part of the raw user actions data may include information regarding date, time, method of a request, uniform resource identifier (URI), response data, status, etc. or any other type of data pertaining to user interactions with the graphical display page which may be recorded at the server 164.

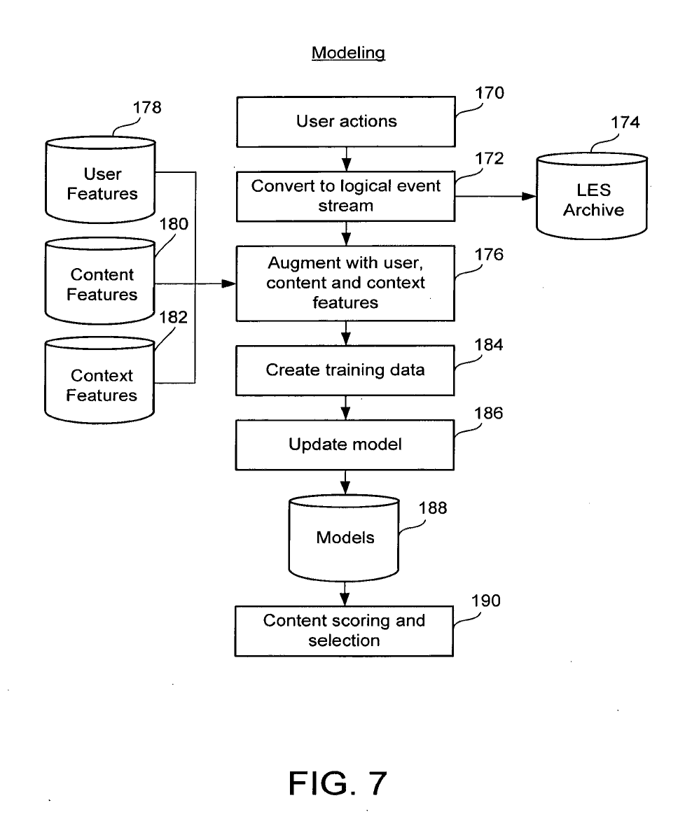

With reference to FIG. 7, a flow diagram illustrating a method for modeling user interactivity with a graphical display page so as to determine the probability that a user will take a particular action, such as selecting a particular piece of content such as a preview icon when it is displayed on the graphical display page, is shown, in accordance with an embodiment of the invention. At operation 172, raw user actions data 170 are converted to a logical event stream. The raw user actions data 170 constitutes raw data which is recorded during the user's interaction with a graphical display page. The conversion process of the operation 172 thus entails determining the logical significance of the raw user actions data 170 for purposes of modeling a user's interactivity with the graphical display page to determine the probability of the user taking a particular action.

In accordance with one embodiment, the raw user actions data 170 may include data from server logs, page tags, and other sources which generate, record or store data from the user interactions with the graphical display page. By way of example only, such data might indicate that a user clicked on a particular link at a specific time, or hovered over a particular icon, or entered data, etc. However, for purposes of modeling user interactions as herein described, the data would be converted to a logical event by determining the logical significance of the raw user action. Thus, by way of example, a recorded raw data event of a user clicking on a particular link might be converted to a logical event by determining that the user click indicates that the user navigated to a web page for the purpose of viewing a particular type of content. Or as another example, a user clicking on a particular link may indicate that the user selected a particular article's preview icon for viewing.

In various embodiments, the raw user actions data 170 may include any type of data which may be recorded during, or which are indicative of or result from, user interactions with a graphical display page. Whereas the logical events may be any events interpreted from the raw user actions data 170 which have a logical significance or are otherwise useful for modeling purposes to determine the probability that a user will take a particular action. The logical events may include events relevant to the articles, such as whether or not a user clicked on, hovered over, selected, or otherwise interacted with a preview icon or expanded preview window of an article which was presented on the graphical display page.

With continued reference to FIG. 7, the logical events generated at operation 172 may be stored in a logical event stream (LES) archive 174. LES archive 174 thus serves as a repository for logical events, and may be accessed as needed for various purposes, including the presently described method for modeling user interactivity. For example, in one embodiment, the LES archive 174 may be configured to store logical events in real-time, and periodically send the accumulated logical events from the most recent time period to the modeling module 94, as described with reference to FIG. 3, so as to update the models. In other embodiments, the LES archive 174 may be configured to store or provide a logical event stream at any time, schedule, or on an as-needed basis.

With continued reference to FIG. 7, at operation 176, the logical event stream is augmented with user features, content features, and context features, which are received from user features storage 178, content features storage 180, and context features storage 182, respectively. The user features, as discussed above, may include data such as age, gender, location, topics and sources of interest to the user, etc. or any other type of data about the user which may be relevant as an attribute for determining the probability that the user will take a particular action. Similarly, the content features, as discussed above, may include data such as the types of content shown on the graphical display page, their size, location, topics, sources, keywords, etc. or any other data describing the content shown on the graphical display page which may be relevant as an attribute for determining the probability that the user will take a particular action. Likewise, the context features, as discussed above, may include data which is descriptive of the context in which the user interacts with the content of the graphical display page, such as the type of device used by the user, the type of page on which the content is being displayed (e.g. a sports page vs. a finance page), etc. or any other contextual data which may be relevant as an attribute for determining the probability that the user will take a particular action. It should be understood that while the foregoing user features, content features, and context features are provided as specific examples of data which are useful for modeling user interactions, any other type of data which may be useful for modeling purposes, as described herein, may be included as well without departing from the scope of the present invention.

With continued reference to FIG. 7, at operation 184, the logical event stream, the user features, the content features, and the context features, are together used to create training data. The training data includes data which can be utilized by a machine learning processor to generate or update models for predictive purposes. Thus, in accordance with an embodiment of the present invention, the training data can include the aforementioned features and logical event stream, which includes data indicating outcomes such as whether or not a user clicked on, hovered over, selected, or otherwise interacted with a particular preview icon or expanded preview window of an article on the graphical display page. At operation 186, the machine learning processor receives this data and generates or updates models which can be utilized to predict the outcomes based on new data. The models are stored in a modeling storage 188. As shown at operation 190, the models in the modeling storage 188 are accessed for utility scoring and selection of content for display on the graphical display page.

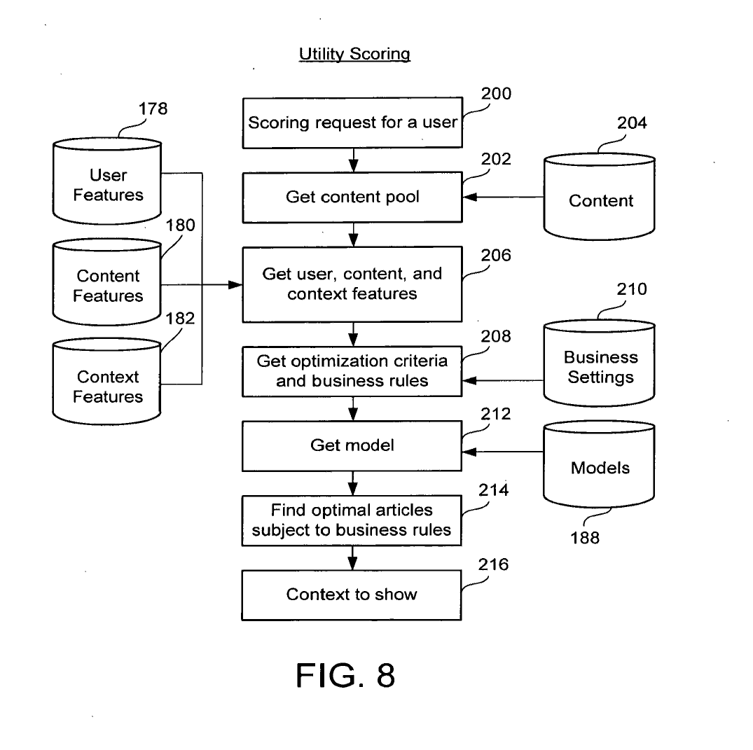

With reference to FIG. 8, a flow diagram illustrating a method for scoring content to be displayed on a graphical display page is shown, in accordance with an embodiment of the invention. At operation 200, a scoring request for a user is received. The scoring request generally results from an action which causes a graphical display page to be rendered to the user. For example, the scoring request may result from the user requesting the graphical display page via their interface (e.g. the user's web browser on a computing device). Or the scoring request for the user may result from some other action which causes the graphical display page to be rendered.

At operation 202, the content pool is retrieved from a content storage 204. The content pool includes those pieces of content which are under consideration for display on the graphical display page, and are therefore to be scored according to the present scoring method. The content storage 204 may include the aforementioned articles storage 106, as well as other types of storage for content or metadata relating to content that is to be considered for display on the graphical display page. In accordance with an embodiment of the invention, the content pool includes articles which are under consideration for display on the graphical display page. The articles may include all articles which have been approved by the articles editors, or selected ones of the articles based on various criteria. For example, in one embodiment, the articles which are included as part of the content pool may be filtered or selected based on the editors' indication of specific target groups. Thus, if the user is determined not to be part of the editors' indicated target group for a certain article, then the specific article would be excluded from the content pool. In other embodiments, the articles may be filtered from or selectively included in the content pool based on any other criteria, whether indicated by the editors or not.

At operation 206, user features are retrieved from the user features database 178, the user features being data which describes the user, and which are useful for application by a model to predict user interactions with the content. In one embodiment, the user features may be stored as part of a user profile for that specific user. In another embodiment, if the identity of the user is unknown, then a generic set of user features is applied. The generic set of user features may be independently determined, or estimated in part based upon other known pieces of data, such as the content and context features. An example of a generic user feature is location, which in a Web context can be inferred from a user's IP address.

Also at operation 206, content features are retrieved from the content features database 180, the content features being data which describes attributes of the content under consideration for display on the graphical display page, and which may be used by a model for prediction of user interactions with the content. For example in one embodiment, wherein the content includes articles, the content features may include descriptive information about the articles, such as the type of article, its features, etc. or any other descriptive information which may be utilized by a model for predicting user interactions with the article.

Also at operation 206, context features are retrieved from the context features database 182, the context features being data which describes the context in which content selected from the content pool will be displayed on the graphical display page. The context features may thus include any data describing the context which is relevant for predicting user interactions with the selected content according to a model. As discussed, such context features may include various features such as the time of day, attributes of a device being utilized by the user to view the graphical display page, the setting of the graphical display page (e.g. type of page, etc.), placement, size or any other feature of the context in which the selected content will be displayed that may be utilized by a model for predicting user interactions.

At operation 208, optimization criteria and business rules are retrieved from a business settings database 210. The optimization criteria may include any criteria according to which the results from a model for predicting user interactions may be optimized, such as those criteria discussed above with reference to the utility optimization interface 110, as well as other criteria. The business rules may include any rules or constraints according to which content from the content pool which has been ranked based on the application of the optimization criteria may be selected. In accordance with one embodiment, the content pool may be ranked based on the application of the optimization criteria to the modeled determination of probabilities of user interactions with the content; and the business rules are applied accordingly to determine which content from the content pool is selected. Examples of the business rules include the editorial constraints as discussed above with reference to the editorial interface 114, as well as other business rules and constraints.

At operation 212, an appropriate model (one or more) is selected from the modeling storage 188 for determining the probability of user interactions with content from the content pool based on the user features, the content features, and the context features. The model is utilized to determine the probability of user interactions with each of the content pieces in the content pool. In accordance with an embodiment of the invention, the model determines the probability that a user will select or otherwise interact with a particular article which is part of the content pool.

At operation 214, the optimal content is found subject to the business rules. In one embodiment, the optimization criteria are applied to the results of the modeling so as to determine an overall score for each piece of content in the content pool. The overall score thus determines a ranked order for the content pieces of the content pool. Based on this ranking, the highest scoring content (or otherwise determined optimal content according to the optimization criteria) which satisfies the business rules are selected for display on the graphical display page. This content constitutes the content to be shown 216, which is ultimately displayed on the graphical display page to the user. It is noted that the results of showing the content 216 are captured as user actions, which in turn are utilized for updating the models, as described above with reference to FIG. 7.

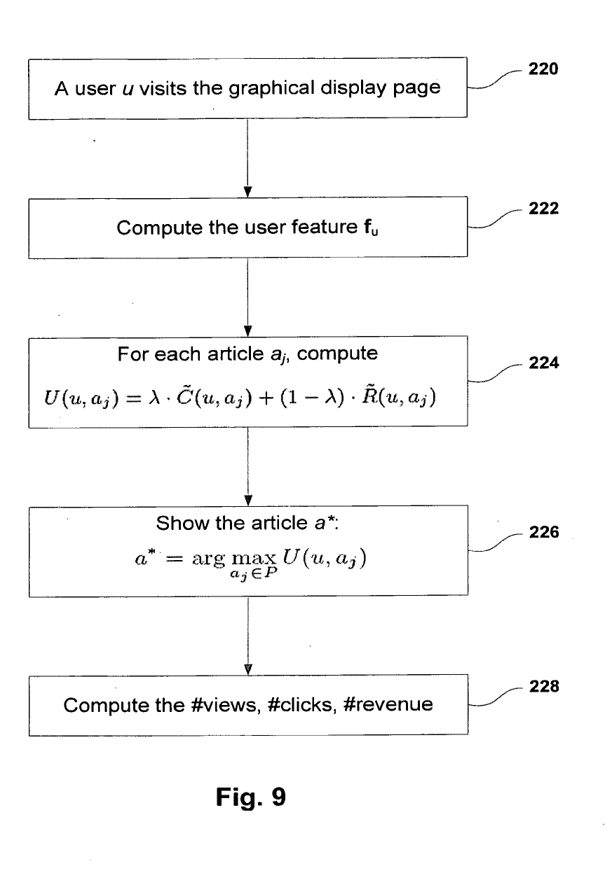

With reference to FIG. 9, a method for determining articles to present on a graphical display page is shown, in accordance with an embodiment of the invention. At method operation 220, a user u visits the graphical display page, for example, by opening or navigating a browser application to the URL of the graphical display page. At method operation 222, the user features fᵤ are determined. The user features fᵤ include various aspects which are known about the user u and which can be utilized in predicting whether the user u is likely to view a particular article. At method operation 224, for each article aⱼ in a pool of articles P, the value of a utility function U is determined. In one embodiment, the utility function U is as follows:

U(u,aⱼ)=λ·C(u,aⱼ)+(1−λ)·R(u,aⱼ)

wherein the value of may vary between zero and one, the function C provides an estimation of the click-through rate (CTR) for the user u for the article aⱼ, and the function R provides an estimation of the expected revenue per view (RPV) for the user u for the article aⱼ. The value of determines the relative weight assigned to the CTR estimation and the RPV estimation. As can be seen, the CTR and RPV estimations are linked in the utility function U such that as one increases, the other decreases. Thus, by selecting the value for one can set the relative weighting of CTR and RPV in the calculation of the utility function U. At method operation 226, the articles a* are presented on the graphical display page, the articles a* being determined according to the following:

a*=arg max U(u,aⱼ)

wherein aⱼεP. Thus, the articles a* are those articles which maximize the utility function U. At method operation 228, data are collected regarding the number of views, clicks, and the actual revenue yields as a result of presenting the articles according the utility function. These data points are then utilized to further refine the functions used to estimate CTR and RPV.

The foregoing utility function U based on CTR and RPV is a simplified example illustrating merely one embodiment of a utility function. In other embodiments, utility functions may be constructed which incorporate any of various measures of interest which relate to user engagement, revenue, business interests, and other considerations in determining which articles to present on the graphical display page. These may include various downstream engagement and revenue metrics in addition to those relating to the initial graphical display page itself.

Moreover, while the foregoing embodiment has been described with reference to various articles, it will be understood by those skilled in the art that in other embodiments, any of various other types of content may be evaluated for display on a graphical display page according to utility functions such as those described herein.

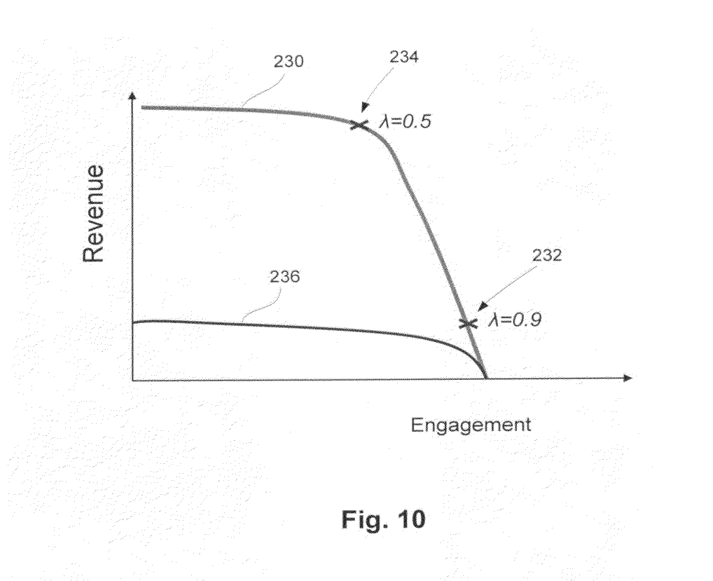

With reference to FIG. 10, a graph illustrating revenue vs. user engagement is shown, in accordance with an embodiment of the invention. In one embodiment, the measure of revenue is RPV, and the measure of user engagement is a clicks-based measure such as CTR, though in other embodiments, other measures relating to revenue and user engagement may be utilized. The curves shown are generated by varying optimization criteria for a pool of content between fully optimizing for revenue and fully optimizing for clicks, according to a utility function of the form λ·clicks+(1−λ)·revenue. Applicants have discovered that varying such optimization criteria produces a curve of the form demonstrated by curve 230. Thus, as demonstrated by curve 230, it is possible to achieve significant revenue gains while sacrificing only a relatively small amount of clicks. When λ=0.9, the balance of revenue and clicks occurs at a point 232 along the curve 230. Whereas when λ=0.5, the balance of revenue and clicks occurs at a point 234 along the curve, providing significantly more revenue, with a comparatively minor loss in clicks. By way of comparison, a curve 236 is less desirable than curve 230 because a fairly large click loss is required for a comparatively small revenue gain.

In view of the foregoing, the value of λ may be selected based on the revenue vs. clicks curve so as to achieve a desired amount of revenue with a tolerable amount of click loss. Moreover, the value of λ may be varied depending on business priorities so as to achieve a specific balance of revenue and clicks. In one embodiment, the value of λ may be set automatically according to the revenue vs. clicks curve so as to achieve a point along the curve having a specified slope.

In various embodiments of the invention, revenue vs. user engagement curves such as the aforementioned (in which user engagement is measured based on clicks) may be constructed and utilized in determining parameters of a utility function as previously described. For example, in one embodiment, revenue vs. user engagement curves may be constructed for various types of classifications of content and users. For example, curves may be constructed for particular types of articles, or for particular demographics of users, such as by age, gender, or location. Accordingly, utility functions may be configured to leverage these curves by, for example, setting tradeoff values (such as λ in the above described embodiments) between various factors in the utility functions based on the tradeoffs represented by the curves.

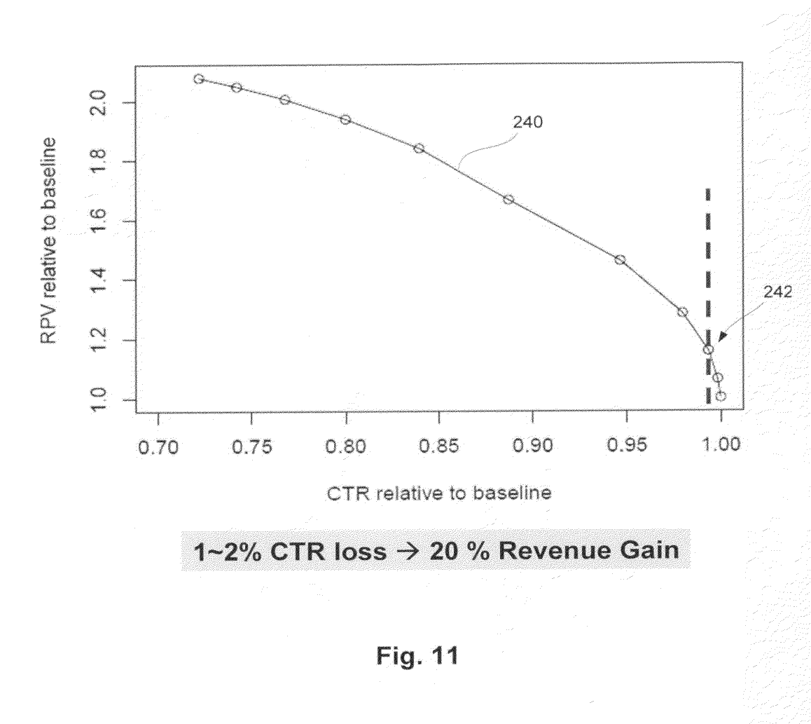

With reference to FIG. 11, a graph illustrating experimental results of RPV vs. CTR is shown, in accordance with an embodiment of the invention. A curve 240 provides the tradeoff between optimization for RPV and optimization for CTR. At a point 242, it is possible to achieve a 20% gain in revenue over optimization for CTR alone, while only tolerating a 1-2% CTR loss. Thus, it may be beneficial to tolerate some loss in CTR so as to achieve significant gains in revenue.

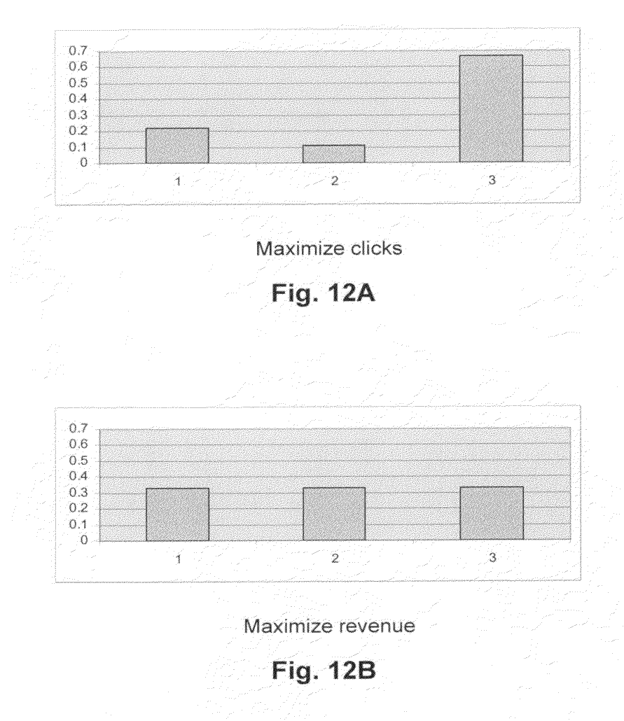

With reference to FIGS. 12A and 12B, graphs illustrating distribution of traffic over three properties are shown, in accordance with an embodiment of the invention. As used herein, traffic is indicative of users visiting or otherwise interacting with properties, each property including one or more graphical display pages, such as web pages. FIG. 12A illustrates a distribution of traffic optimized so as to maximize user clicks on content across the three properties. FIG. 12B illustrates a distribution of traffic optimized so as to maximize revenue earned over the same properties (primarily through advertisement revenue). As can be seen, the traffic distribution when maximizing user clicks is different than the traffic distribution when maximizing revenue. Thus, it is not possible to achieve both maximization of user clicks and revenue simultaneously. However, by presenting content so as to adjust traffic across the properties, it may be possible to achieve significant gains in revenue without sacrificing a large amount of clicks, as has been discussed above.

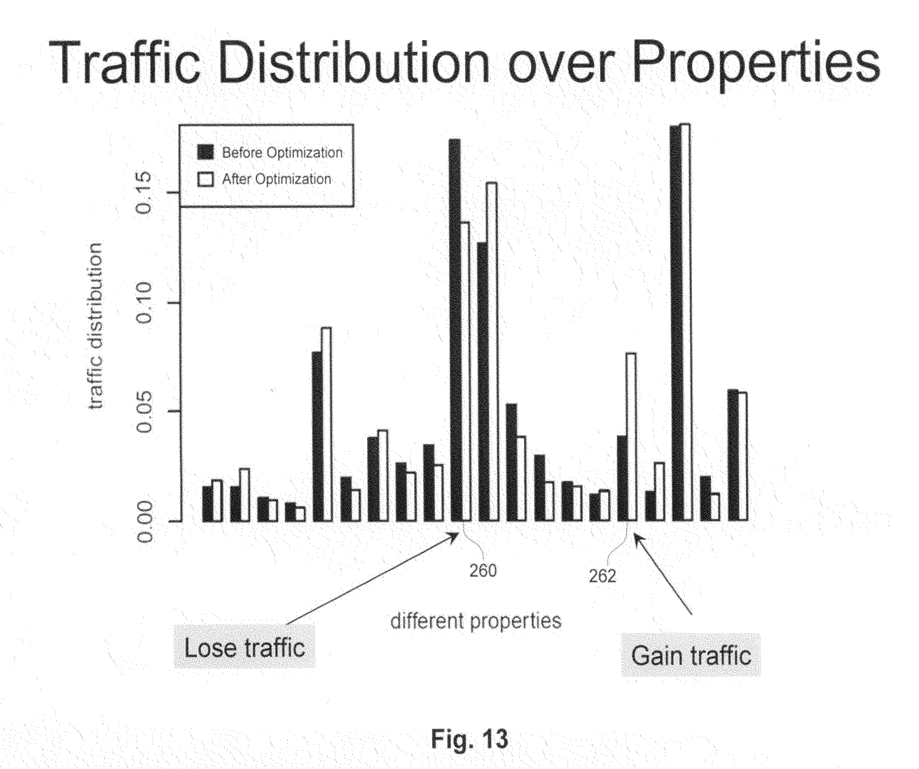

With reference to FIG. 13, a graph illustrating traffic distribution across various properties before and after optimization of content has been performed so as to achieve certain objectives, such as a particular balance of revenue vs. user engagement, in accordance with an embodiment of the invention. In one embodiment, the content optimized consists of preview icons and expanded preview windows of articles which are presented in a priority orientation on a portal page, as discussed above. By clicking on one of the preview icons or expanded preview windows, users navigate from the portal page to one of the various properties which then displays the article content. As can be seen, some properties, such as property 260, experience a loss in traffic after optimization, whereas other properties, such as property 262, experience a gain in traffic. Thus, by optimizing the content presented on a graphical display page as discussed previously, it is possible to affect the distribution of traffic across properties, which will in turn affect the aggregate amounts of revenue and user engagement.

While embodiments of the invention have generally been described with reference to the presentation of articles on a graphical display page, which is an example of a visually based interface, it is recognized that the principles herein described may also apply to other types of visually-based interfaces. Moreover, the principles of the present invention may also be applied to other modes of presenting articles to a user. For example, in other embodiments of the invention, the foregoing articles may be presented via an audio-based interface.

In one specific embodiment, a user may be presented with audio content that is selectable by the user. In various embodiments, the method of selection may encompass various interfaces such as a voice-recognition interface, key/button type interface, touch interface, etc. For example, a user might interact with audio content over a telephone, and utilize either or both of a voice-recognition type interface and/or the buttons of the telephone to provide input regarding selection of audio content. Then, in accordance with principles described above regarding modeling user interactions, content scoring, and selection of content based on constraints, one or more articles may be presented to the user in an audio-based manner.

In still other embodiments of the invention, various types of interfaces for the presentation of content might be combined. For example, a user might interact with a visually-based interface for the selection and viewing of preview icons of articles; however, the article content of the articles might be presented in an audio-based manner. Or in an opposite manner, a user might interact with an audio-based interface for the selection of preview icons of articles; whereas, the article content of the articles might be presented in a visually-based manner. In various other embodiments of the invention, any of multiple types of interfaces may be combined for the presentation of content to users in accordance with the principles described herein.

Embodiments of the invention as herein described may utilize relational database systems as are known in the art. Examples of such database systems include MySQL, Oracle, and Access. Various operations as described above may be effected by performance of an operation via a relational database management system. Such database systems may be embodied in one or more server computers, which may be configured as part of a network of computers.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, and other optical and non-optical data storage devices. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overall operations are performed in the desired way.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for presenting recommended content from a plurality of content, the method comprising:
determining a plurality of content including two or more pieces of content;
for each piece of content in the plurality of content, determining two or more utility components;
for each piece of content in the plurality of content, determining an overall utility based on the two or more utility components;
determining a ranked order of the pieces of content in the plurality of content based upon the overall utility;
presenting a portion of the pieces of content on a graphical display page in a priority orientation based on the ranked order of the pieces of content.

2. The method of claim 1, wherein the utility components include a user experience utility value determined based upon a probability that a user will select the piece of content when presented.

3. The method of claim 1, wherein the utility components include an economic utility value determined based upon an expected commercial value of advertisements to be presented when a particular piece of content is selected.

4. The method of claim 2, further comprising,
determining user features of a user, the user features including data which describes characteristics of the user; and
wherein the user experience utility value is determined based at least in part on the user features.

5. The method of claim 4, wherein the user features are selected from the group consisting of age, gender, location, topics of interest, sources of interest, and content preferences of the selected user when interacting with the graphical display page.

6. The method of claim 1, wherein the portion of the pieces of content are presented on the graphical display page in a priority orientation based on the ranked order of the pieces of content and satisfaction of a set of constraints.

7. The method of claim 6, wherein the set of constraints includes a variety constraint, the variety constraint requiring that the portion of the pieces of content include more than one type of content.

8. The method of claim 6, wherein the set of constraints includes a placement constraint, the placement constraint requiring that a specific piece of content be included in the portion of the pieces of content which are presented.

9. The method of claim 1, wherein the pieces of content include content selected from one or more of the following: news, pictures, text, photos, graphics, audio, video, stories, games, shopping, weather, sports, entertainment, business, finance, health, science, calendar, personal planner, email, real estate, music, maps, personals, travel, groups, instant messaging, tracking, monitoring, utilities, and editors.

10. The method of claim 1, wherein the pieces of content are preview icons, each preview icon defining a link to a corresponding article content when presented on the graphical display page.

11. A method for presenting articles from a plurality of articles on a graphical display page, the method comprising:
obtaining a plurality of advertisements from advertisers, the advertisers defining content for the advertisements, the advertisers assigning a commercial value to each of the advertisements, the commercial value representing a cost to the advertiser when the advertisement is presented to or selected by a user;
obtaining a plurality of articles, each of the articles having article content and a preview icon, the preview icon defining a link to its corresponding article content when presented on a graphical display page;
identifying a user profile for a selected user that interfaces with a graphical display page that is to present one or more of the preview icons of the obtained articles;
obtaining a probability value for the selected user for each one of the plurality of articles, the probability value defining which ones of the preview icons of the plurality of articles is most likely to be viewed by the selected user;
obtaining a commercial value for the selected user for each one of the plurality of articles, the commercial value determined based on advertisements which are to be displayed with a given article's article content when presented;
combining the probability value with the commercial value; and
presenting a set of preview icons of the articles on the graphical display page in a priority orientation, such that the priority orientation defines an optimal placement based on the commercial value and the probability value.

12. The method of claim 11, wherein the user profile for the selected user includes data which describes characteristics of the selected user.

13. The method of claim 12, wherein the characteristics of the selected user are selected from the group including age, gender, location, topics of interest, sources of interest, and content preferences of the selected user when interacting with the graphical display page.

14. The method of claim 13, wherein the content preferences of the selected user are determined by tracking the interactions of the selected user with the graphical display page.

15. The method of claim 11, wherein the probability value for each one of the plurality of articles is determined based on the user profile and characteristics of the one of the plurality of articles.

16. A computer program product comprising program instructions embodied on a computer readable medium, the program instructions comprising:
program instructions for determining a plurality of articles, each article in the plurality of articles including article content and a corresponding preview icon, the preview icon defining a link to the corresponding article content when presented;
program instructions for determining a user experience utility value for each article in the plurality of articles;
program instructions for determining an economic utility value for each article in the plurality of articles;
program instructions for determining a ranked order of the articles based upon each article's user experience utility value and economic utility value;
program instructions for presenting a portion of the preview icons of the articles on a graphical display page in a priority orientation based on the ranked order of the articles.

17. The computer program product of claim 16, wherein the user experience utility value is determined based upon a probability that a user will select the article's preview icon when presented.

18. The computer program product of claim 16, wherein the economic utility value is determined based upon an expected commercial value of advertisements to be presented with the article content of a particular article when the article's preview icon is selected.

19. The computer program product of claim 16, further comprising,
program instructions for determining user features of a user, the user features including data which describes characteristics of the user; and
wherein the user experience utility value is determined based at least in part on the user features.

20. The computer program product of claim 19, wherein the user features are selected from the group consisting of age, gender, location, topics of interest, sources of interest, and content preferences of the selected user when interacting with the graphical display page.
